(19) United States
(12) Patent Application Publication
(10) Pub. No.: US 2024/0294132 A1
(43) Pub. Date: Sep. 5, 2024

(54) COLLISION DETERMINATION DEVICE AND ACTIVATION CONTROL DEVICE

(71) Applicant: DENSO CORPORATION, Kariya-city (JP)

(72) Inventors: Mami SAKATA, Kariya-city (JP); Yuki IGUCHI, Kariya-city (JP)

(21) Appl. No.: 18/612,747

(22) Filed: Mar. 21, 2024

Related U.S. Application Data
(63) Continuation of application No. PCT/JP2022/031752, filed on Aug. 23, 2022.

(30) Foreign Application Priority Data
Sep. 22, 2021 (JP) 2021-154726

(51) Int. Cl. B60R 21/0132; B60R 21/00; G01P 15/18

(52) U.S. Cl. CPC B60R 21/0132; G01P 15/18; B60R 2021/0004

(57) ABSTRACT

A collision determination device for determining a type of collision of a vehicle, includes an acceleration acquisition unit and a determination unit. The acceleration acquisition unit is configured to acquire a longitudinal-direction acceleration and a lateral-direction acceleration output from side sensors provided on left and right sides of a vehicle body, which detect the longitudinal-direction acceleration and the lateral-direction acceleration. The determination unit is configured to determine a type of collision based on relational information indicating a relationship of the longitudinal-direction acceleration and the lateral-direction acceleration detected by the acceleration acquisition unit to the longitudinal-direction acceleration and the lateral-direction acceleration according to the type of collision.

### CROSS-REFERENCE TO RELATED APPLICATION

This application is a continuation application of International Application No. PCT/JP2022/031752 filed Aug. 23, 2022 which designated the U.S. and claims priority to Japanese Patent Application No. 2021-154726 filed with the Japan Patent Office on Sep. 22, 2021, the contents of each of which are incorporated herein by reference.

### BACKGROUND

### Technical Field

The present disclosure relates to a collision determination device configured to determine a collision type of a vehicle. The present disclosure also relates to an activation control device configured to control activation of an occupant protection device mounted to the vehicle.

### Related Art

A known activation control device controls activation of airbag devices mounted to a vehicle when the vehicle collides with a colliding object. This activation control device includes front sensors, a floor sensor and an output control unit. The floor sensor is provided more rearward in the vehicle than the front sensors. The output control unit controls the output of the inflator when activating the airbag devices based on detected values of the front sensors and the floor sensor.

### BRIEF DESCRIPTION OF THE DRAWINGS

In the accompanying drawings:

FIG. 1 is a plan view of a vehicle on-board system configured as an activation control device or collision determination device according to one embodiment;

FIG. 2 is a block diagram illustrating an example of a collision determination logic configuration of a determination unit depicted in FIG. 1;

FIG. 3 is a graph illustrating relational information used in the logic configuration depicted in FIG. 2;

FIG. 4 is a graph illustrating relational information used in the logic configuration depicted in FIG. 2;

FIG. 5 is a schematic diagram illustrating contents of relational information depicted in FIG. 4;

FIG. 6 is a graph illustrating an example of outputs of front and side sensors depicted in FIG. 1 in the event of occurrence of a collision;

FIG. 7 is a graph illustrating an example of outputs of front and side sensors depicted in FIG. 1 in the event of occurrence of a collision;

FIG. 8 is a block diagram illustrating another example of the collision determination logic configuration of the determination unit depicted in FIG. 1; and

FIG. 9 is a graph illustrating relational information used in the logic configuration depicted in FIG. 8.

### DESCRIPTION OF SPECIFIC EMBODIMENTS

According to the configuration of the above known activation control device as disclosed in JP 2000-219098 A, accurately detecting the impact during a collision makes it possible to accurately determine a collision type, such as a low-speed collision, a high-speed collision, an irregular collision when the colliding object is soft. Therefore, according to such a configuration, it is possible to optimise the output of the inflators of the airbag devices according to the collision type.

For example, there may be a case where another vehicle approaching a subject vehicle from an oblique forward direction of the subject vehicle does not collide with the front surface of the subject vehicle, but with the front portion of the side (e.g., the front fender) of the subject vehicle. In this respect, further performance improvements may continue to be pursued in this type of device with respect to accurately detecting such a collision type and reliably activating the occupant protection device according to the collision type.

In view of the foregoing, it is desired to have a technology for more accurately detecting a collision type and more reliably activating the occupant protection device according to the collision type.

A collision determination device is configured to determine a type of collision of a vehicle. According to one aspect of the present disclosure, the collision determination device includes an acceleration acquisition unit configured to acquire a longitudinal-direction acceleration and a lateral-direction acceleration output from side sensors provided on left and right sides of a vehicle body, which detect the longitudinal-direction acceleration and the lateral-direction acceleration, and a determination unit configured to determine a type of collision based on relational information indicating a relationship of the longitudinal-direction acceleration and the lateral-direction acceleration detected by the acceleration acquisition unit to the longitudinal-direction acceleration and the lateral-direction acceleration according to the type of collision.

An activation control device is configured to control activation of an occupant protection device to be mounted to a vehicle. According to one aspect of the present disclosure, the activation control device includes side sensors provided on left and right sides of a vehicle body, which detect a longitudinal-direction acceleration and a lateral-direction acceleration; and an electronic control device configured to acquire the longitudinal-direction acceleration and the lateral-direction acceleration output from the side sensors to control activation of the occupant protection device.

The electronic control device includes an acceleration acquisition unit configured to acquire the longitudinal-direction acceleration and the lateral-direction acceleration output from the side sensors, and a determination unit configured to determine whether to activate the occupant protection device for frontal collisions based on relational information indicating a relationship of the longitudinal-direction acceleration and the lateral-direction acceleration detected by the acceleration acquisition unit to the longitudinal-direction acceleration and the lateral-direction acceleration according to a type of collision.

In each part of the present application document, the reference signs in parentheses attached to the components or the like merely indicate examples of the correspondence between the components or the like and the specific components described in relation to the embodiments described below. Therefore, the present disclosure is not limited by the above reference signs.

Some embodiments of the present disclosure are described below with reference to the accompanying drawings. Modifications of the embodiments are listed at the end of the description of those embodiments, as such modifications may impede consistent understanding of the embodiments if inserted into the embodiment description.

### Vehicle On-Board System Configuration

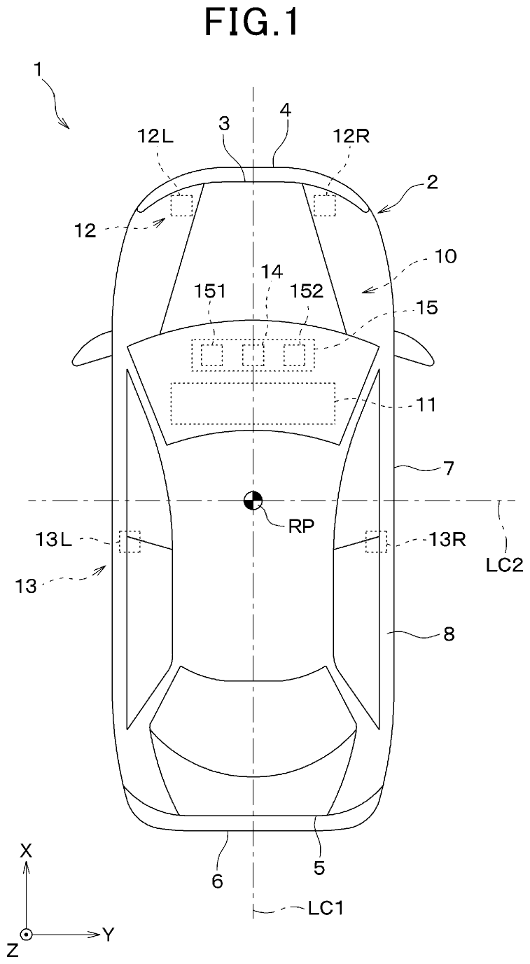

First, a schematic configuration of a vehicle 1 to which the present embodiment is applied will now be described with reference to FIG. 1. For illustration purposes, the three-dimensional XYZ coordinate system is set as illustrated in FIG. 1. The X-axis direction is the front-rear direction, that is, the longitudinal direction of the vehicle, and is parallel to the vehicle centre line LC1. The vehicle centre line LC1 is a virtual straight line passing through a reference point RP that is the centre point or centre of gravity of the vehicle 1 in plan view. The positive direction of the X-axis corresponds to the direction of travel of the vehicle when the vehicle is travelling forward. The Y-axis direction is the left-right direction, that is, the lateral direction of the vehicle. The virtual straight line passing through the reference point RP and parallel to the Y-axis direction is referred to as a lateral line LC2. The Z-axis direction is the vehicle height direction that is parallel to the direction of gravity action when the vehicle 1 is stably placed on a horizontal surface with the vehicle allowed to move.

The vehicle 1 is a so-called automobile, including a box-shaped body 2. A front bumper 4 is provided on the front surface 3 of the vehicle body 2. A rear bumper 6 is provided on the rear surface 5 of the vehicle body 2. Side panels 8, such as door panels, are provided on the sides 7 of the vehicle body 2.

A vehicle on-board system 10 is mounted to the vehicle 1. The vehicle 1 equipped with the vehicle on-board system 10 according to the present embodiment is referred to as a “subject vehicle” in the following. The vehicle on-board system 10 as an activation control device according to the present embodiment is configured to control activation of an occupant protection device 11 mounted to the subject vehicle. That is, the vehicle on-board system 10, which may also be referred to as an occupant protection system, is provided to protect occupants of the subject vehicle by the occupant protection device 11 in the event of a collision between the subject vehicle and an object outside the vehicle. In the present embodiment, the occupant protection device 11 is a protection device for frontal collisions and includes a driver's airbag and a front passenger seat airbag, etc.

A front sensors 12 are provided at the front portion of the vehicle body 2. The front sensors 12 are mounted on an unshown body part which supports the front bumper 4 from the inside of the vehicle body 2. The front sensors 12 are provided on the left and right sides of the vehicle body 2. That is, a left front sensor 12L and a right front sensor 12R are mounted on the vehicle body 2. The left front sensor 12L and the right front sensor 12R are arranged symmetrically about the vehicle center line LC1. The front sensors 12 are so-called uniaxial sensors configured to detect the longitudinal acceleration (i.e., the acceleration in the X-axis direction) acting on the vehicle body 2 in the event of a collision between the subject vehicle and an object and to output detection results.

Side sensors 13 are provided on the left and right portions of the vehicle body 2. The side sensors 13 are disposed at both ends of the vehicle body 2 in the lateral direction and at the centre of the vehicle in the longitudinal direction. That is, the left-side sensor 13L and the right-side sensor 13R are mounted on the vehicle body 2. The left-side sensor 13L and the right-side sensor 13R are arranged symmetrically around the vehicle centre line LC1. The side sensors 13 are so-called biaxial sensors which are configured to detect the acceleration in the lateral direction (that is, the acceleration in the Y-axis direction) and the acceleration in the longitudinal direction acting on the vehicle body 2 when a collision occurs between the subject vehicle and an object, and to output detection results.

In addition to the occupant protection device 11, the front sensors 12 and the side sensors 13, the vehicle on-board system 10 includes a floor sensor 14. The floor sensor 14 is arranged on the vehicle centre line LC1 in plan view and is accommodated in the vehicle body 2. The floor sensor 14 is a so-called uniaxial sensor and is configured to detect the longitudinal acceleration acting on the vehicle body 2 in the event of a collision between the subject vehicle and an object, and to output detection results. The floor sensor 14 is incorporated in the electronic control unit 15.

The electronic control device 15 is configured as an airbag ECU and is configured to activate the occupant protection device 11 based on outputs of the front sensors 12, the side sensors 13 and the floor sensor 14. ECU is an abbreviation for Electronic Control Unit. In the present embodiment, the electronic control device 15 is configured as a vehicle on-board microcomputer including a CPU, a ROM, a RAM, a non-volatile rewritable memory, etc., which are not shown. The non-volatile rewritable memory is a storage device that can rewrite information while the power supply is on, but can retain information that is non-rewritable while the power supply is off, such as a flash ROM. The ROM, RAM and non-volatile rewritable memory are non-transitory tangible storage media. The electronic control device 15 is configured to control the operation of the vehicle on-board system 10 by reading and executing a control program stored in the ROM or non-volatile rewritable memory.

In the present embodiment, the electronic control device 15 acting as a collision determination device is configured to acquire the longitudinal acceleration and the lateral acceleration output from the side sensors 13 to determine a type of collision with the subject vehicle and to control activation of the occupant protection device 11. Specifically, the electronic control device 15 is configured to determine, based on the outputs of the side sensors 13, whether the collision that has occurred is of a collision type that requires activation of the occupant protection device 11 (i.e., typically a frontal collision or a side collision). The electronic control device 15 is configured to activate the occupant protection device 11 when determining that the collision that has occurred is of a collision type that requires activation of the occupant protection device 11.

More particularly, the electronic control device 15 includes an acceleration acquisition unit 151 and a determination unit 152. The acceleration acquisition unit 151 is provided to acquire the acceleration in the longitudinal direction (hereinafter, the longitudinal-direction acceleration) and the acceleration in the lateral direction (hereinafter, the lateral-direction acceleration) output from the side sensors 13. The determination unit 152 is provided to determine the collision type and to determine whether to activate the occupant protection device 11, based on the longitudinal-direction acceleration and the lateral-direction acceleration acquired by the acceleration acquisition unit 151 and predefined relational information. The “relational information” is information indicating a relationship between the longitudinal-direction acceleration and the lateral-direction acceleration according to the type of collision, e.g. a map or a look-up table for distinguishing between a plurality of collision types using the longitudinal-direction acceleration and the lateral-direction acceleration as parameters. Specifically, in the present embodiment, the relational information is provided to distinguish between a first type of collision and a second type of collision in a two-dimensional coordinate space with the first axis indicating the longitudinal-direction acceleration and the second axis indicating the lateral-direction acceleration. The first type of collision is the type of collision in which there is a high need to activate the occupant protection device 11, and is typically a frontal collision. On the other hand, the second type of collision is a collision type in which the need for activation of the occupant protection device 11 is lower than in a frontal collision, and is typically a side collision.

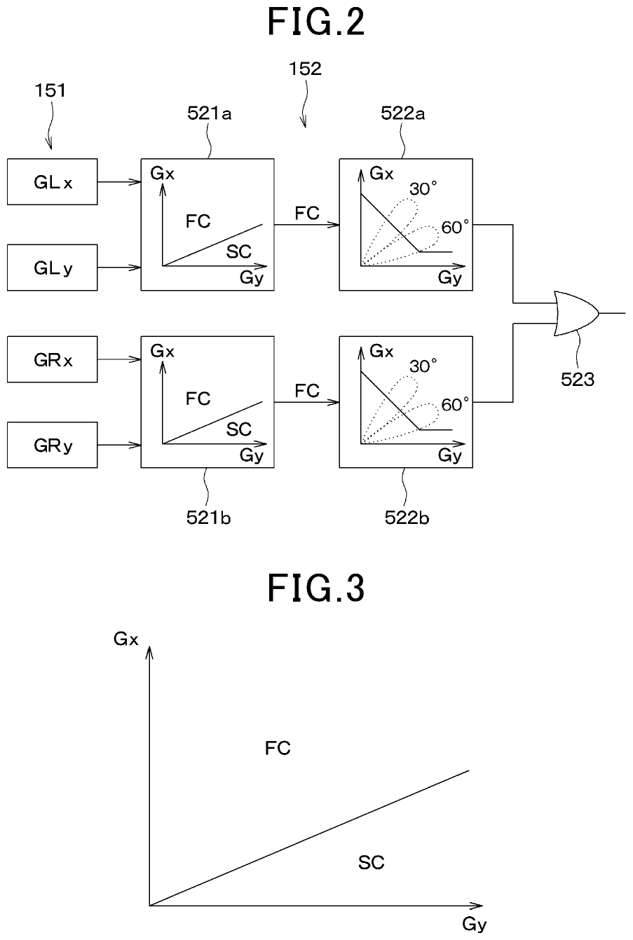

FIG. 2 illustrates an example of the logic configuration of the determination unit 152. In FIG. 2, “Gx” indicates the longitudinal-direction acceleration, and “Gy” indicates the lateral-direction acceleration. “FC” indicates the first type of collision and is an abbreviation for frontal collision. “SC” is the second type of collision and is an abbreviation for side collision. The left-side X-axis direction acceleration GLx is the longitudinal-direction acceleration detected and output by the left-side sensor 13L. The left-side Y-axis direction acceleration GLy is the lateral-direction acceleration detected and output by the left-side sensor 13L. The right-side X-axis direction acceleration GRx is the longitudinal-direction acceleration detected and output by the right-side sensor 13R. The right-side Y-axis direction acceleration GRy is the lateral-direction acceleration detected and output by the right-side sensor 13R. Referring to FIG. 2, the determination unit 152 includes a first left-side determination logic 521a, a first right-side determination logic 521b, a second left-side determination logic 522a, a second right-side determination logic 522b, and a frontal-collision determination logic 523.

The first left-side determination logic 521a is configured to determine whether the collision that has occurred is the first type of collision or the second type of collision based on the left-side X-axis direction acceleration GLx and the left-side Y-axis direction acceleration GLy and the first relational information as illustrated in FIG. 3. As illustrated in FIG. 3, the first relational information is provided based on the relationship that the lateral-direction acceleration is higher than the longitudinal-direction acceleration in the second type of collision, that is, the side collision. Specifically, this first relational information is a map or look-up table for discriminating between the first type of collision and the second type of collision by a straight line Gx=k·Gy passing through the origin (0, 0) in two-dimensional coordinates (Gy, Gx) where the horizontal axis is the lateral-direction acceleration Gy and the vertical axis is the longitudinal-direction acceleration Gx. 0<k<1. That is, the first left-side determination logic 521a determines occurrence of the first type of collision when (Gy, Gx)=(GLy, GLx) is within the region FC above the right ascending line as illustrated in FIG. 3. Similarly, the first right-side determination logic 521b is configured to determine the collision that has occurred is the first type of collision or the second type of collision based on the right-side X-axis direction acceleration GRx and the right-side Y-axis direction acceleration GRy, and the first relational information as illustrated in FIG. 3.

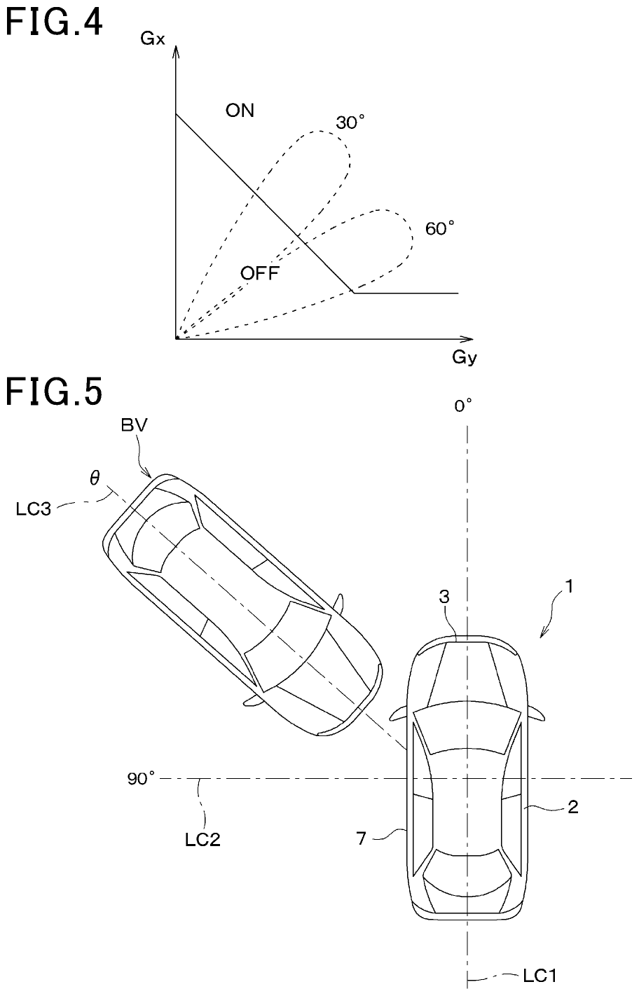

The second left-side determination logic 522a is provided to operate when the first type of collision is determined to have occurred by the first left-side determination logic 521a. The second left-side determination logic 522a is configured to determine activation of the occupant protection device 11 based on the left-side X-axis direction acceleration GLx and the left-side Y-axis direction acceleration GLy and second relational information as illustrated in FIG. 4. The second right-side determination logic 522b is configured to operate when the first type of collision is determined to have occurred by the first right-side determination logic 521b. The second right-side determination logic 522b is configured to determine activation of the occupant protection device 11 based on the right-side X-axis direction acceleration GRx and the right-side Y-axis direction acceleration GRy and the second relational information as illustrated in FIG. 4. That is, in the present embodiment, the determination unit 152 is configured to determine whether the first type of collision requiring activation of the occupant protection device 11 has occurred after determining that the collision that has occurred is different from the second type of collision.

As illustrated in FIG. 4, the second relational information is a map or look-up table for determining whether to activate the occupant protection device 11 based on the longitudinal-direction acceleration Gx and the lateral-direction acceleration Gy. In FIG. 4, “ON” indicates that the occupant protection device 11 is to be activated and “OFF” indicates that the occupant protection device 11 is not to be activated. The line that demarcates “ON” and “OFF” indicates an activation threshold for determining whether a collision has occurred that requires activation of the occupant protection device 11. That is, the second relational information corresponds to activation threshold information that defines such an activation threshold. The activation threshold information is provided based on the relational information as indicated by the straight line descending to the right in the FIG. 4, such that as the lateral-direction acceleration Gy increases from the low acceleration region to the high acceleration region (that is, as it increases from zero), the longitudinal-direction acceleration Gx corresponding to the activation threshold decreases. Such activation threshold information is also provided in a broken line such that the longitudinal-direction acceleration Gx corresponding to the activation threshold becomes constant when the lateral-direction acceleration Gy exceeds a predefined value. The dotted lines in FIG. 4 indicate acceleration regions that can occur at collision angles θ of 30 and 60 degrees, as illustrated in FIG. 5. FIG. 5 illustrates a situation where another vehicle BV approaching the subject vehicle from an oblique forward direction of the subject vehicle does not collide with the front surface 3 of the subject vehicle, but with the front portion of the side 7 of the subject vehicle. As illustrated in FIG. 5, the collision angle θ is an angle between the centre line LC3 of the other vehicle, which is a virtual straight line corresponding to the direction of travel of the other vehicle BV colliding with the subject vehicle, and the centre line LC1 of the subject vehicle. As illustrated in FIGS. 4 and 5, the activation threshold information is provided based on the relationship such that the longitudinal-direction acceleration Gx corresponding to the activation threshold decreases as the collision angle θ increases.

In the present embodiment, the second left-side determination logic 522a is configured to output an activation signal when (Gy, Gx)=(GLy, GLx) is within the ON region as illustrated in FIG. 4. Similarly, the second right-side determination logic 522b is configured to output an activation signal when (Gy, Gx)=(GRy, GRx) is within the ON region as illustrated in FIG. 4. The frontal-collision determination logic 523 is provided to output a trigger signal when the activation signal is output by at least one of the second left-side determination logic 522a and the second right-side determination logic 522b. The trigger signal is a signal output to the occupant protection device 11 to activate the occupant protection device 11.

### Overview of Operations

An overview of the operations according to the present embodiment will now be described with reference to FIGS. 1 to 7, together with advantages provided by the present embodiment.

There may be a case where another vehicle BV approaching the subject vehicle from an oblique forward direction of the subject vehicle does not collide with the front surface 3 of the subject vehicle, but with a front portion of the side 7 of the subject vehicle. Such a type of collision is referred to as a “non-frontal oblique collision” in the following. FIG. 5 illustrates a typical case of the non-frontal oblique collision in which the left front portion of the vehicle body 2 of the subject vehicle, which is traveling straight ahead along the center line LC1 of the subject vehicle, collides with another vehicle BV, which is traveling straight ahead along the center line LC3 of the other vehicle. FIG. 5 illustrates such a typical case of the non-frontal oblique collision, where the impact position is at the left front fender of the subject vehicle and the collision angle θ is set to 45°.

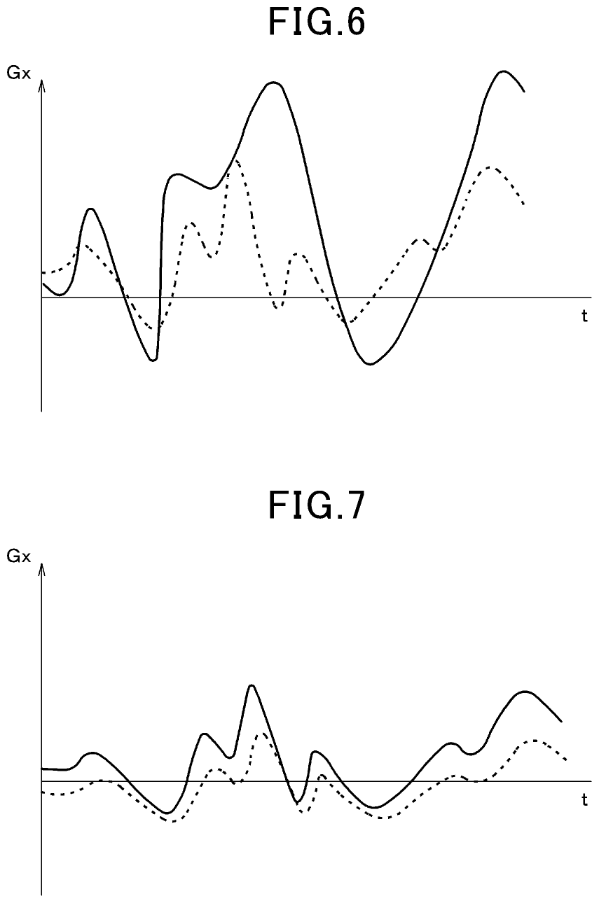

FIG. 6 illustrates outputs of the impacted side sensors, i.e., the left front sensor 12L and the left-side sensor 13L, in the collision example depicted in FIG. 5. In FIG. 6, the dotted line indicates the output of the left front sensor 12L and the solid line indicates the output of the left-side sensor 13L. FIG. 7 illustrates outputs of the non-impacted side sensors, i.e., the right front sensor 12R and the right-side sensor 13R, in the collision example depicted in FIG. 5. In FIG. 7, the dotted line indicates the output of the right front sensor 12R and the solid line indicates the output of the right-side sensor 13R.

In the case of a non-frontal oblique collision (e.g. typically, the collision angle θ is in the range of 30-60 degrees), the impact on the portion of the vehicle body 2 to which the front sensor 12 is attached is relatively small. As illustrated in FIGS. 6 and 7, inputs of acceleration to the front sensors 12 caused by the non-frontal oblique collision are relatively small. Thus, there is still room for improvement in the conventional determination method, as disclosed in JP 2000-219098 A, based on the longitudinal-direction accelerations detected by the front sensors 12, with respect to accurately detecting such a type of collision and reliably activating the occupant protection device 11 according to the type of collision.

On the other hand, as illustrated in FIG. 6, it can be seen that a non-frontal oblique collision transfers a relatively high longitudinal-direction acceleration to the side sensor 13 on the impacted side. However, the magnitude of the longitudinal-direction accelerations received by the side sensor 13 is affected by the collision angle θ, in addition to the driving condition and relative speed. That is, even if the relative speeds and accelerated/decelerated states of the subject vehicle and the other vehicle BV immediately before the collision are the same, the smaller the collision angle θ, the higher the longitudinal-direction acceleration received by the side sensor 13. On the other hand, the larger the collision angle θ, the lower the longitudinal-direction acceleration received by the side sensor 13. Then, at θ=90 degrees, a complete side collision occurs.

As above, for the non-frontal oblique collision, the output differs between the longitudinal- and lateral-direction accelerations, depending on the collision angle θ. Thus, as illustrated in FIG. 4, setting the determination threshold according to the collision angle θ enables reliable collision determination over a wide range of collision angles θ. However, for a side collision having a relatively large magnitude, there is a concern that a longitudinal acceleration input may also occur to cause a determination that a frontal collision has occurred to be made.

In view of the foregoing, in the present embodiment, taking into account the fact that in a side collision the lateral-direction acceleration is higher than the longitudinal-direction acceleration, the relational information illustrated in FIG. 3 is used to determine the first type of collision and then the relational information illustrated in FIG. 4 is used to activate the occupant protection device 11. That is, in the present embodiment, the following two properties are used to determine whether the first type of collision has occurred that requires activation of the occupant protection device 11 for frontal collisions.
In a side collision, the lateral-direction acceleration is higher than the longitudinal-direction acceleration.
In a non-frontal oblique collision, the smaller the collision angle θ, the higher the longitudinal-direction acceleration sensed by the side sensors 13.

According to the present embodiment, it is possible to accurately detect a non-frontal oblique collision, which is conventionally difficult to accurately detect. In addition, according to the present embodiment, the logic for discriminating between the first type of collision and the second type of collision makes it possible to reliably detect a frontal collision even by using the side sensors 13 which receive large inputs in a side collision. Furthermore, according to the present embodiment, it is possible to reliably activate the occupant protection device 11 in a non-frontal oblique collision where the collision angle θ is small and activation of the occupant protection device 11 is required for a frontal collision.

### Modifications

The present disclosure is not limited to the above embodiments. Accordingly, changes can be made to the above embodiment as appropriate. Representative examples of modifications are described below. In the following description of the modification examples, differences from the above embodiment will mainly be described. In addition, the same number is attached to parts that are identical or equal to each other in the above embodiment and the modification examples. Therefore, in the following description of the modification examples, the description in the above embodiment may be used as appropriate for the constituent elements having the same numbers as in the above embodiment, unless there is any technical contradiction or special additional explanation.

The present disclosure is not limited to the specific device configuration described in the above embodiment. That is, for example, as described in the above embodiment, it is possible to detect a frontal collision using the side sensors 13 and activate the occupant protection device 11 for frontal collisions. Therefore, the front sensors 12 may be omitted. However, from the point of view of earlier determination of a typical frontal collision and from the point of view of redundancy, the front sensors 12 and frontal collision determination using it may be provided in parallel with collision determination using the side sensors 13 described in the above embodiment. The same applies to the floor sensor 14, which may be omitted from the point of view of making the present disclosure at least feasible, but may be used in conjunction with it.

The present disclosure may also be preferably applied to cases where the occupant protection device 11 other than for the frontal collision is provided.

As illustrated in FIG. 2, in the above embodiment, a determination is first made by the first left-side determination logic 521a and the first right-side determination logic 521b as to whether the collision that has occurred is of the type of collision not requiring activation of the occupant protection device 11 for frontal collisions. Such a determination is referred to as a “side/frontal-collision determination”. The “type of collision not requiring activation of the occupant protection device 11 for frontal collisions” is typically a side collision, but also includes a non-frontal oblique collision having a large collision angle θ near 90 degrees. In the above embodiment, a determination is then made by the second left-side determination logic 522a and the second right-side determination logic 522b as to whether a collision requiring activation of the occupant protection device 11 for frontal collisions has occurred. Such a determination is referred to as an “activation determination”.

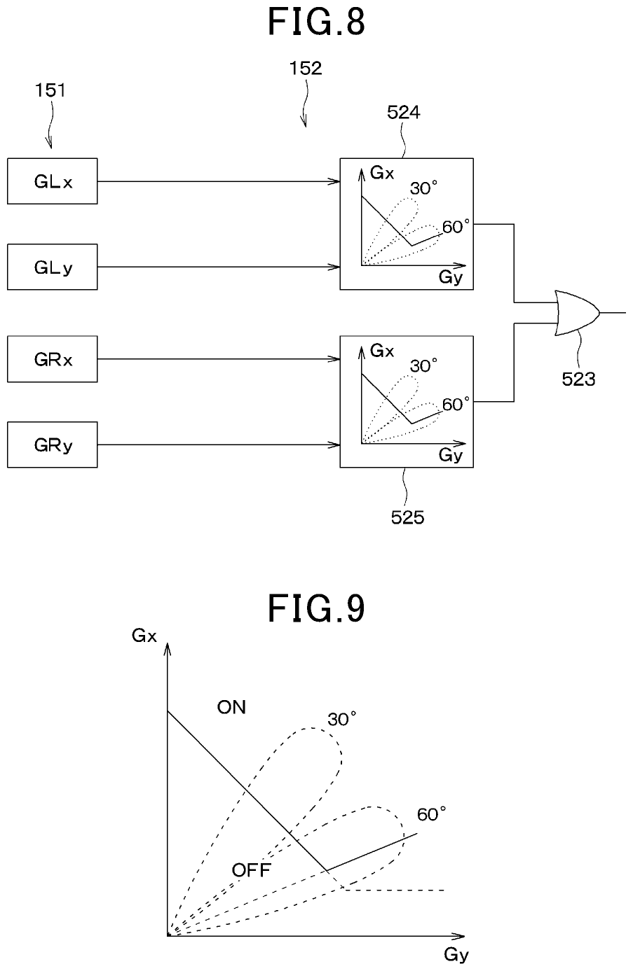

That is, in the above embodiment, side/frontal-collision determination and activation determination are separately performed in a two-stage logic. However, the present disclosure is not limited to such an embodiment. For example, side/frontal-collision determination and activation determination may be performed simultaneously in a single-stage logic. The logic configuration illustrated in FIG. 8 corresponds to this modification. That is, the determination unit 152 illustrated in FIG. 8 includes a frontal-collision determination logic 523, a left-side determination logic 524 and a right-side determination logic 525. The left-side determination logic 524 corresponds to the first left-side determination logic 521a and the second left-side determination logic 522a integrated together. The right-side determination logic 525 corresponds to the first right-side determination logic 521b and the second right-side determination logic 522b integrated together.

Specifically, the left-side determination logic 524 is configured to determine activation of the occupant protection device 11 for frontal collisions based on the left-side X-axis direction acceleration GLx and the left-side Y-axis direction acceleration GLy, and relational information as illustrated in FIG. 9. The right-side determination logic 525 is configured to determine activation of the occupant protection device 11 for frontal collisions based on the right-side X-axis direction acceleration GRx and the right-side Y-axis direction acceleration GRy, and relational information as illustrated in FIG. 9. The relational information illustrated in FIG. 9 is a map or look-up table for determining whether to activate the occupant protection device 11 for frontal collisions based on the longitudinal-direction acceleration Gx and the lateral-direction acceleration Gy. The relational information is a combination of the first relational information illustrated in FIG. 3 and the second relational information illustrated in FIG. 4. The frontal-collision determination logic 523 is provided to output a trigger signal when an activation signal is output from at least one of the left-side determination logic 524 and the right-side determination logic 525. According to this modification, the logic configuration may be simplified.

The whole or part of the electronic control device 15 may be configured as a digital circuit configured to implement the above-described operations, such as an ASIC or FPGA. ASIC is an abbreviation for Application Specific Integrated Circuit. FPGA is an abbreviation for Field Programmable Gate Array. That is, the vehicle on-board microcomputer section and the digital circuit section can coexist in the electronic control device 15.

Each of the above-described functional configurations and methods may be realized by a dedicated computer provided by configuring a processor and a memory programmed to execute one or more functions embodied by computer programs. Alternatively, each of the functional configurations and methods described above may be realized by a dedicated computer provided by configuring a processor with one or more dedicated hardware logic circuits. Alternatively, each of the functional configurations and methods described above may be realized by one or more dedicated computers configured by combining a processor and a memory programmed to execute one or more functions with a processor configured by one or more hardware logic circuits. Further, the computer program may also be stored in a computer-readable non-transitory tangible storage medium as an instruction to be executed by a computer. That is, each of the above-described functional configurations and methods can also be represented as a computer program including procedures for implementing each of the above-described functions or methods, or as a non-transitory tangible storage medium storing said program.

It is unnecessary to say that the elements constituting the above embodiments are not necessarily essential unless explicitly stated as essential or obviously considered essential in principle. In addition, when a numerical value such as the number, value, amount, or range of a component(s) of any of the above-described embodiments is mentioned, it is not limited to the particular number or value unless expressly stated otherwise or unless it is obviously limited to the particular number or value in principle, etc. When the shape, positional relationship, or the like of a component(s) or the like of any of the embodiments is mentioned, it is not limited to the shape, positional relationship, or the like unless explicitly stated otherwise or unless it is limited to the specific shape, positional relationship, or the like in principle, etc.

The modifications are also not limited to the above examples. That is, part of one embodiment and part of another embodiment may be combined with each other. A plurality of modifications may be combined with each other. Further, all or some of the above embodiments and all or some of the modifications may be combined with each other.

What is claimed is:

1. A collision determination device for determining a type of collision of a vehicle, comprising:
an acceleration acquisition unit configured to acquire a longitudinal-direction acceleration and a lateral-direction acceleration output from side sensors provided on left and right sides of a vehicle body, which detect the longitudinal-direction acceleration and the lateral-direction acceleration;
a determination unit configured to determine a type of collision based on relational information indicating a relationship of the longitudinal-direction acceleration and the lateral-direction acceleration detected by the acceleration acquisition unit to the longitudinal-direction acceleration and the lateral-direction acceleration according to the type of collision.

2. The collision determination device according to claim 1, wherein
the determination unit is configured to determine the type of collision based on the relational information provided to distinguish between a first type of collision and a second type of collision in a two-dimensional coordinate space with a first axis indicating the longitudinal-direction acceleration and a second axis indicating the lateral-direction acceleration, and
the first type of collision has a higher need for activation of an occupant protection device for frontal collisions than the second type of collision.

3. The collision determination device according to claim 2, wherein
the relational information is provided based on a relationship that the lateral-direction acceleration is higher than the longitudinal-direction acceleration in the second type of collision.

4. The collision determination device according to claim 3, wherein
the determination unit is configured to determine whether the first type of collision has occurred after determining that a collision that has occurred is of a different type than the second type of collision.

5. The collision determination device according to claims 2, wherein
the relational information includes activation threshold information that defines an activation threshold for determining occurrence of the first type of collision, and
the activation threshold information is provided based on a relationship such that the longitudinal-direction acceleration corresponding to the activation threshold decreases as the lateral-direction acceleration increases from a low acceleration region to a high acceleration region.

6. The collision determination device according to claim 5, wherein
the activation threshold information is provided based on a relationship such that the longitudinal-direction acceleration corresponding to the activation threshold decreases as a collision angle, which is an angle between a center line of the vehicle and a direction of travel of another vehicle that has collided with the vehicle, increases.

7. An activation control device for controlling activation of an occupant protection device to be mounted to a vehicle, comprising:
side sensors provided on left and right sides of a vehicle body, which detect a longitudinal-direction acceleration and a lateral-direction acceleration; and
an electronic control device configured to acquire the longitudinal-direction acceleration and the lateral-direction acceleration output from the side sensors to control activation of the occupant protection device, wherein
the electronic control device comprises:
an acceleration acquisition unit configured to acquire the longitudinal-direction acceleration and the lateral-direction acceleration output from the side sensors; and
a determination unit configured to determine whether to activate the occupant protection device for frontal collisions based on relational information indicating a relationship of the longitudinal-direction acceleration and the lateral-direction acceleration detected by the acceleration acquisition unit to the longitudinal-direction acceleration and the lateral-direction acceleration according to a type of collision.

8. The activation control device according to claim 7, wherein
the determination unit is configured to determine the type of collision based on the relational information provided to distinguish between a first type of collision and a second type of collision in a two-dimensional coordinate space with a first axis indicating the longitudinal-direction acceleration and a second axis indicating the lateral-direction acceleration, and
the first type of collision has a higher need for activation of the occupant protection device for frontal collisions than the second type of collision.

9. The activation control device according to claim 8, wherein
the relational information is provided based on a relationship that the lateral-direction acceleration is higher than the longitudinal-direction acceleration in the second type of collision.

10. The activation control device according to claim 9, wherein
the determination unit is configured to determine whether the first type of collision has occurred after determining that a collision that has occurred is of a different type than the second type of collision.

11. The activation control device according to claim 8, wherein
the relational information includes activation threshold information that defines an activation threshold for determining occurrence of the first type of collision that has a high need for activation of the occupant protection device for frontal collisions, and
the activation threshold information is provided based on a relationship such that the longitudinal-direction acceleration corresponding to the activation threshold decreases as the lateral-direction acceleration increases from a low acceleration region to a high acceleration region.

12. The activation control device according to claim 11, wherein
the activation threshold information is provided based on a relationship such that the longitudinal-direction acceleration corresponding to the activation threshold decreases as a collision angle, which is an angle between a center line of the vehicle and a direction of travel of another vehicle that has collided with the vehicle, increases.
